(19) United States
(12) Patent Application Publication
(10) Pub. No.: US 2004/0260612 A1
(43) Pub. Date: Dec. 23, 2004

(54) Mini bar system

(75) Inventors: Itzhak Raz, Kfar Saba (IL); Albert Ben-Porat, Tel Aviv (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Bar Comp Hi-Tech Ltd.

(21) Appl. No.: 10/740,635

(22) Filed: Dec. 22, 2003

Related U.S. Application Data
(63) Continuation-in-part of application No. 10/465,239, filed on Jun. 20, 2003.

(51) Int. Cl. G06F 17/60

(52) U.S. Cl. 705/22; 340/5.92

(57) ABSTRACT

A minibar system for supplying a plurality of inventory items, including a plurality of minibars. Each of the minibars having a control system and a minibar power modem. The control system being configured to monitor a removal of one of the inventory items and prepare a data package about the removal. The system also includes a processor and a central power modem. The processor is operationally connected to the central power modem. The central power modem and the minibar power modem of each of the minibars are electrically connected to a wiring system so that the minibars and the processor can communicate over the wiring system. The processor is configured to process data packages received from the minibars.

This application is a continuation-in-part of co-pending U.S. application Ser. No. 10/465,239 filed 20 Jun. 2003.

### FIELD AND BACKGROUND OF THE INVENTION

The present invention relates to minibars and, in particular, it concerns a network of computerized minibars controlled by a central computer system.

By way of introduction, in most hotel rooms there are provided units, typically having a refrigerated and non-refrigerated section for storing small bottles of alcoholic beverages, soft drinks and other items including snack foods therein. The hotel guest is provided with a key which enables the guest to remove any item as desired, and the guest is charged for such items in their hotel bill.

As opposed to a standard vending machine, a guest using the minibar does not have to pay for the items before removing the item. The guest simply removes the items as required and is charged for all the used items on leaving the hotel. Therefore, the hotel needs to make an accurate and timely accounting of the items used. This requires the hotel to perform a check of the inventory of the minibar after each guest leaves their room for the final time, which slows down the billing process. Additionally, as most guests typically check out of a hotel during the same period, typically the morning hours, it is impractical for a large hotel to perform this last minute inventory check for every guest, thereby losing possible revenue related to the minibars.

Moreover, a minibar generally needs to be restocked more frequently than a standard vending machine. This is due to the minibar being used by one or two individuals who probably select the same item repeatedly, whereas a vending machine which is used by many people does not require such close inventory monitoring as it is more likely that most of the items will be taken from the vending machine. Therefore, it is important to know immediately when an item is removed from the minibar to enable immediate refilling if necessary.

Of most relevance to the present invention is U.S. Pat. No. 5,930,766 to Gibb, which teaches a minibar having infrared sensor arrangements disposed therein. The minibar is connected to a central computer in the hotel via a wireless communication link or a standard twisted pair communication cable system. The inventory of the minibar is monitored by the sensors. When a guest removes an item of inventory, the corresponding sensor is triggered. Using this method the hotel can track the inventory of individual minibars for restocking and billing purposes. Additionally, the hotel can lock and unlock the minibars from a central location as well as keeping track of and controlling the minibar temperature.

A shortcoming of the aforementioned system is due to the means of communication employed between the minibars and the central computer. Standard wireless links are not suitable for large hotels. Wireless communication in large hotels would require additional transmitter/receiver stations on each floor and/or section of the hotel. Installing additional transmitter/receiver stations is labor intensive and can be expensive.

If a standard twisted pair cable communication cable system is used, the cables need to be laid in the hotel. This installation is very expensive and may be very impractical in very large and/or old hotels.

U.S. Pat. No. 5,452,344 to Larson, U.S. Pat. No. 5,835,005 to Furukawa, et al. and U.S. Pat. No. 6,492,897 to Movery, Jr teach communication over power lines. Although, as discussed above, the functionality of vending machines is dissimilar to minibars, Furukawa, et al teach connecting a plurality of vending machines to a communications terminal over power lines using power modems. Furukawa, et al. also teaches an embodiment where some vending machines are connected to a first power line and other vending machines are connected to a second power line and another set of vending machines connected to a third power line. The first power line, second power line and third power line are all out of phase with each other. Furukawa, et al. teaches that power modems cannot be used when the vending machines are installed on power lines having differing phases and network coupling of the different phases is necessary.

It should be noted that minibar systems which are installed in large hotels typically require that the minibars receive their power a three-phase electricity supply, that is, from power lines having different phases, due to the size of the hotel.

There is therefore a need for a system for providing reliable communication between minibars and a central control computer terminal in a large hotel, the system being cheap to install and maintain even in old and/or large hotels. Additionally, the system will make use of existing building infrastructure.

### SUMMARY OF THE-INVENTION

The present invention is a minibar system construction and method of operation thereof.

According to the teachings of the present invention there is provided a minibar system for supplying a plurality of inventory items, comprising: (a) a plurality of minibars, each of the minibars having a control system and a minibar power modern, the control system being configured to monitor a removal of one of the inventory items and prepare a data package about the removal; (b) a wiring system; (c) a processor; and (d) a central power modem, the processor being operationally connected to the central power modem, the central power modem and the minibar power modem of each of the minibars being configured and electrically connected to the wiring system so that the minibars and the processor can communicate over the wiring system; the processor being configured to process data packages received from the minibars.

According to a further feature of the present invention, the wiring system includes coaxial cable.

According to a further feature of the present invention, the wiring system is a cable TV wiring system.

According to a further feature of the present invention, the wiring system is a telephone wiring system.

According to a further feature of the present invention, the control system is configured to monitor a replacement of one of the inventory items.

According to a further feature of the present invention, the minibars and the processor are configured, such that, a command can be sent from the processor to one of the minibars, such that, the one minibar performs a function.

According to a further feature of the present invention: (a) each of the minibars has a door and a locking device; (b) the locking device is configured to lock the door; and (c) the minibars and the processor are configured, such that, a command can be sent from the processor to lock the door of one of the minibars.

According to a further feature of the present invention: (a) each of the minibars has an output unit; and (b) the minibars and the processor are configured, such that, a command can be sent from the processor to actuate the output unit of one of the minibars.

According to a further feature of the present invention, the output unit is a display device.

According to the teachings of the present invention there is also provided a minibar for supplying a plurality of inventory items, comprising: (a) a control system configured to monitor a removal of one of the inventory items and prepare a data package about the removal; and (b) a power modem configured to send the data package from the control system over a wiring system. According to a further feature of the present invention the wiring system includes coaxial cable.

According to a further feature of the present invention, the wiring system is a cable TV wiring system.

According to a further feature of the present invention, the wiring system is a telephone wiring system.

According to a further feature of the present invention the control system is configured to monitor a replacement of one of the inventory items.

According to a further feature of the present invention the power modem and the control system are configured, such that, a command can be received over the wiring system by the control system, such that, the control system performs a function.

According to a further feature of the present invention, there is also provided a door and a locking device, the locking device being configured to lock the door, the power modem and the control system being configured, such that, a command can be received over the wiring system by the control system in order to lock the door.

According to a further feature of the present invention, there is also provided an output unit, the power modem and the control system being configured, such that, a command can be received over the wiring system by the control system in order to actuate the output unit.

According to a further feature of the present invention the output unit is a display device.

### BRIEF DESCRIPTION OF THE DRAWINGS

The invention is herein described, by way of example only, with reference to the accompanying drawings, wherein:

FIG. 1 is a schematic view of a minibar system that is constructed and operable in accordance with a preferred embodiment of the invention;

FIG. 2 is a schematic view of a minibar system that is constricted and operable in accordance with an alternate embodiment of the present invention;

FIG. 3 is a schematic view of the configuration of a power modem of the minibar system of FIG. 1 and FIG. 2; and

FIG. 4 is a schematic view of a minibar for use with the minibar system of FIG. 1 and FIG. 2.

### DESCRIPTION OF THE PREFERRED EMBODIMENTS

The present invention is a minibar system construction and method of operation thereof.

The principles and operation of a minibar system according to the present invention may be better understood with reference to the drawings and the accompanying description.

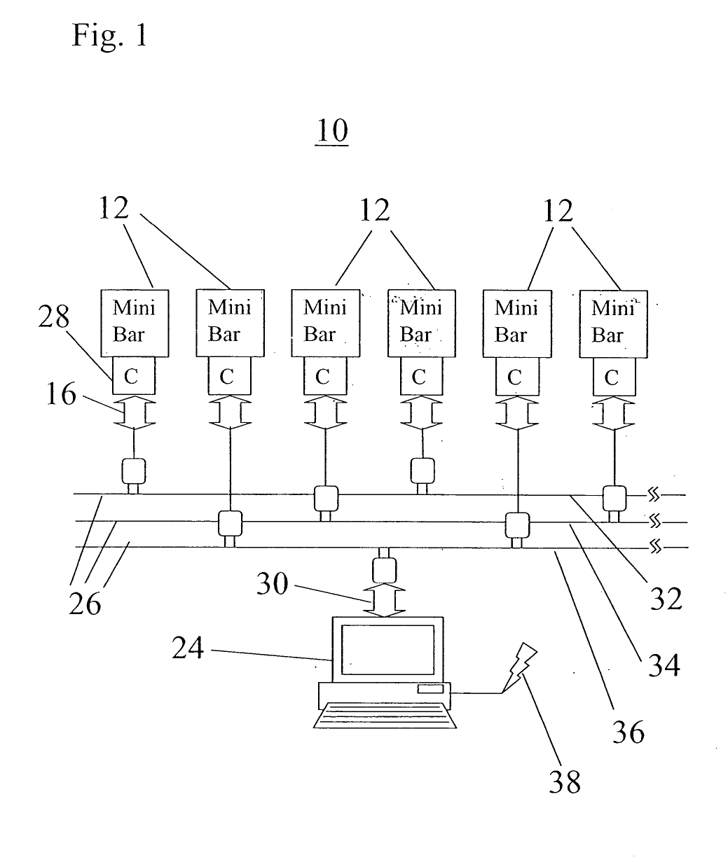

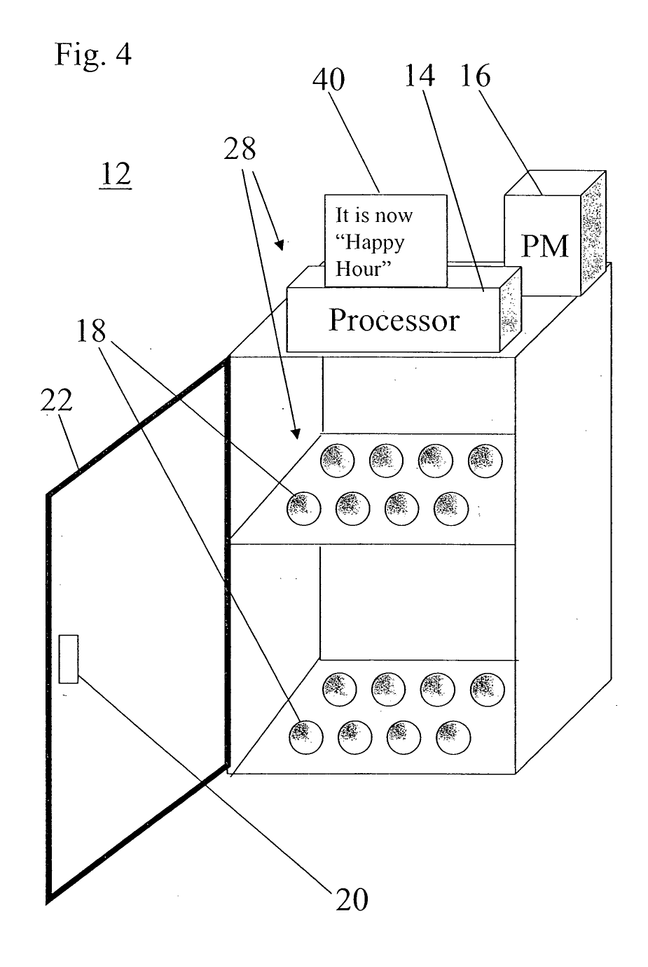

Reference is now made to FIG. 1, which is a schematic view of a minibar system 10 that is constructed and operable in accordance with a preferred embodiment of the present invention. Minibar system 10 is configured for supplying a plurality of inventory items to customers, generally guests in hotel rooms. Minibar system 10 includes a plurality of minibars 12, which are connected to a central processor 24 via an electrical wiring system 26. Electrical wiring system 26 is configured for carrying alternating current and minibars 12 are powered by electrical wiring system 26. Each minibar 12 is defined as a unit configured for supplying a plurality of inventory items to one or more identifiable customers, the unit being at least partially refrigerated, the items not being paid for by the customers prior to removal of the items from minibar 12. Each minibar 12 has a control system 28, which is configured to monitor a removal of one of the inventory items and prepare a data package about the removal. Control system 28 is described in more detail with reference to FIG. 4. Each minibar 12 has a power modem 16. Additionally, central processor 24 is operationally connected to a power modem 30. Central processor 24 and power modem 30 are typically connected using a communication cable. Optionally, central processor 24 and power modem 30 are connected via a wireless link. A power modem is a modem, which enables data communication over standard power lines. Power modems 16 and power modem 30 are electrically connected to electrical wiring system 26 so that control systems 28 and central processor 24 communicate over electrical wiring system 26. Central processor 24 is configured to process the data packages received from control systems 28. Therefore, central processor 24 is able to track the inventory of minibars 12 for billing and restocking purposes. Central processor 24 is typically a computer processor with a user terminal having a monitor and keyboard. Alternatively, central processor 24 is a server of a computer network, which has many user terminals. An Internet link 38 or other wide area network link can be provided to link central processor 24 to other computer systems, for example, to central accounting functions or to external suppliers of food and drink for minibars 12.

In large installations, such as hotels, in order to provide adequate electrical power supply to all of minibars 12, electrical wiring system 26 is configured as a three-phase electrical wiring system having three power-lines 32, 34, 36. Power lines 32, 34, 36 have mutually exclusive phases. Some minibars 12 are electrically connected to power line 32. Other minibars 12 are electrically connected to power line 34 and yet other minibars 12 are electrically connected to power line 36. Central processor 24 is electrically connected to power line 36. Communication between power modems 16 and power modem 30 across the three-phases of electrical wiring system 26 is possible due to the proximity of power line 32, power line 34 and power line 36 at one or more points within electrical wiring system 26. In addition to the proximity of power lines 32, 34, 36, power modems 16, 30 need. to be configured to enable communication across the three-phases of electrical wiring system 26. Additionally, power modems 16 and power modem 30 need to enable bidirectional communication between control systems 28 and central processor 24 to provide functionality required in minibar system 10, as will be discussed below with reference to FIG. 4. Power modems 16, 30 code and modulate data packages for sending over electrical wiring system 26. Additionally, power modems 16, 30 performing demodulation and decoding functions when receiving data from electrical wiring system 26. It will be appreciated by those skilled in the art that power modem 16 and power modem 30 can be identical. Suitable power modems for performing the functions of power modems 16, 30 are commercially available from Itran Communications Limited of 9 Yehoshua Hatzoref Street, Beer Sheva, Israel.

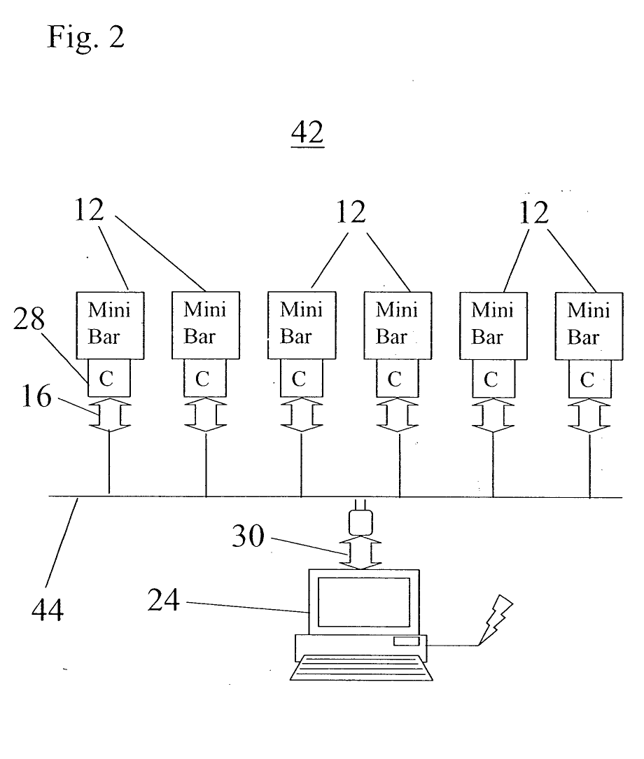

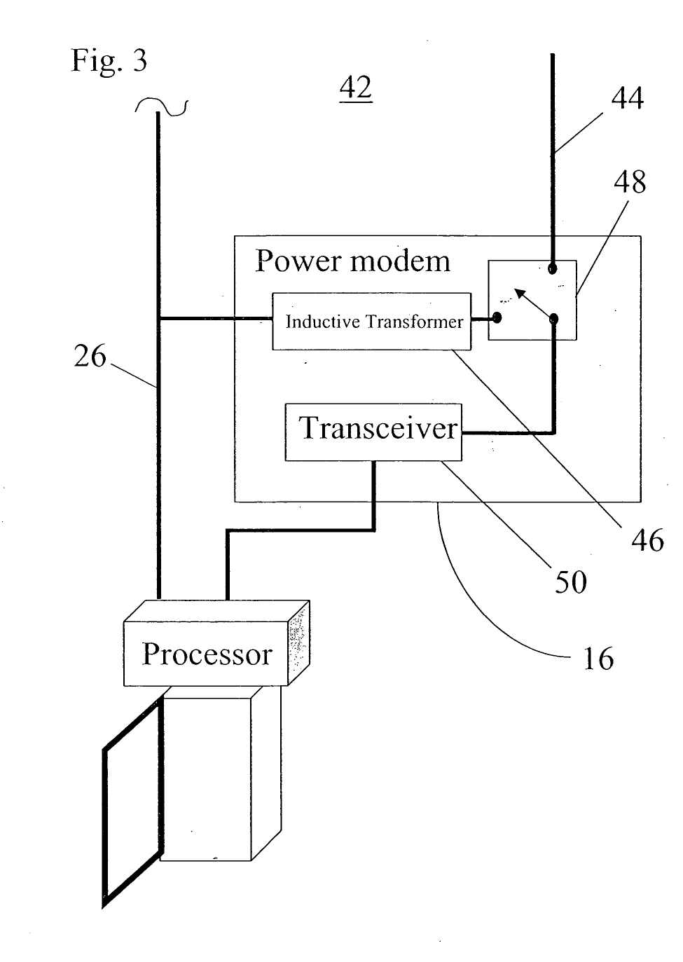

Reference is now made to FIG. 2, which is a schematic view of a minibar system 42 that is constructed and operable in accordance with an alternate embodiment of the present invention. Minibar system 42 is the same as minibar system 10 except that data communication takes place over any wiring system 44 having two wires which carry an electric current, for example, but not limited to a coaxial cable wiring system, a telephone wiring system, a cable TV wiring system. Electrical wiring system 26 is only used to power minibars 12. As described above with reference to FIG. 1, a power modem is a modem, which enables data communication over standard power lines. However, in accordance with the present invention, power modems are configured for effective data communication over any two wires carrying an electrical current. As the voltage and current carried by wiring system 44 is significantly lower than the voltage and current carried by electrical wiring system 26, power modems 16, 30 are configured to enable data communication over wiring system 44, as will be described with reference to FIG. 3. Minibar system 42 includes minibars 12, which are connected to central processor 24 via wiring system 44. Each minibar 12 has one power modern 16. Additionally, central processor 24 is operationally connected to power modem 30. Power modems 16 and power modem 30 are electrically connected to wiring system 44 so that control systems 28 and central processor 24 communicate over wiring system 44. Central processor 24 is configured to process the data packages received from control systems 28. Therefore, central processor 24 is able to track the inventory of minibars 12 for billing and restocking purposes.

Referenee is now made to FIG. 3, which is a schematic view of the configuration of power modem 16 of minibar system 10 of FIG. 1 and minibar system 42 of FIG. 2. Power modem 16 includes a transceiver 50 and a inductive transformer 46, which is disposed between power modem 16 and electrical wiring system 26. Therefore, when data communication is via electrical wiring system 26, as with minibar system 10, electrical wiring system 26 is connected to transceiver 50 via transformer 46. When data communication is via wiring system 44, as with minibar system 42, wiring system 44 is connected to transceiver 50 such that transformer 46 is bypassed. A switch 48 is typically disposed in power modem 16 such that power modem 16 can either send/receive data via electrical wiring system 26 or wiring system 44. It will be appreciated by those ordinarily skilled in the art that when data communication is via wiring system 44, transformer 46 can be removed from power modem 16. It will be appreciated by those ordinarily skilled in the art that the configuration of power modem 30 can be the same as power modem 16.

Reference is now made to FIG. 4, which is a schematic view of minibar 12 for use with minibar system 10 of FIG. 1 and minibar system 42 of FIG. 2. Control system 28 typically includes a plurality of inventory control sensor arrangements 18 and a minibar processor 14. Sensor arrangements 18 are disposed in minibar 12. Each sensor arrangement 18 is configured to sense the removal or replacement of one of the inventory items. Sensor arrangement 18 is typically implemented as a micro-switch, which is disposed below an inventory item, the removal of the inventory item triggering the micro-switch. Alternatively, sensor arrangement 18 is implemented as one or more optical sensors, which sense the removal an inventory item. Each minibar also includes a door 22. Control system 28 also includes a locking device 20, which is configured to lock and unlock door 22. Minibar processor 14 has an interface (not shown) with minibar 12, such that, minibar processor 14 interfaces with components of minibar 12 such as sensor arrangements 18, locking device 20, a thermostat (not shown) of minibar 12, a refrigeration unit (not shown) of minibar 12, an output unit 40 of minibar 12. Output unit 40 is typically a display device or a loud speaker. Therefore, minibar processor 14 in conjunction with sensor arrangements 18 monitors the removal and replacement of inventory items from minibar 12. Minibar 12 can also be configured to sense when door 22 is open. Minibar processor 14 is also configured to prepare data packages in relation to the removal and replacement of inventory items. Additionally, minibar processor 14 and central processor 24 (FIG. 1) are configured, such that, a command can be sent from central processor 24 to lock or unlock door 22 or to perform other functions, such as, increasing or decreasing cooling of minibar 12 and informing guests of events, such as, “happy hour” via displaying a message on output unit 40. Therefore, power modems 16 and power modem 30 (FIG. 1) need to be configured to enable bidirectional communication between minibars 12 and central processor 24 (FIG. 1). Minibar processor 14 is typically a computer processor with custom software installed. Alternatively, minibar processor 14 is a tailored electronic circuit, such as taught by U.S. Pat. No. 5,930,766 to Gibb. It will be appreciated by those skilled in the art that minibar processor 14 and power modem 16 can be implemented as a unitary device. Additionally, it will be appreciated by those skilled in the art how to construct control system 28 including sensor arrangements 18 and minibar processor 14.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A minibar system for supplying a plurality of inventory items, comprising:
(a) a plurality of minibars, each of said minibars having a control system and a minibar power modem, said control system being configured to monitor a removal of one of the inventory items and prepare a data package about said removal;
(b) a wiring system;
(c) a processor; and
(d) a central power modem, said processor being operationally connected to said central power modem, said central power modem and said minibar power modem of each of said minibars being configured and electrically connected to said wiring system so that said minibars and said processor can communicate over said wiring system; said processor being configured to process data packages received from said minibars.

2. The system of claim 1, wherein said wiring system includes coaxial cable.

3. The system of claim 1, wherein said wiring system is a cable TV wiring system.

4. The system of claim 1, wherein said wiring system is a telephone wiring system.

5. The system of claim 1, wherein said control system is configured to monitor a replacement of one of the inventory items.

6. The system of claim 1, wherein said minibars and said processor are configured, such that, a command can be sent from said processor to one of said minibars, such that, said one minibar performs a function.

7. The system of claim 1, wherein:
(a) each of said minibars has a door and a locking device;
(b) said locking device is configured to lock said door; and
(c) said minibars and said processor are configured, such that, a command can be sent from said processor to lock said door of one of said minibars.

8. The system of claim 1, wherein:
(a) each of said minibars has an output unit; and
(b) said minibars and said processor are configured, such that, a command can be sent from said processor to actuate said output unit of one of said minibars.

9. The system of claim 8, wherein said output unit is a display device.

10. A minibar for supplying a plurality of inventory items, comprising:
(a) a control system configured to monitor a removal of one of the inventory items and prepare a data package about said removal; and
(b) a power modem configured to send said data package from said control system over a wiring system.

11. The minibar of claim 10, wherein said wiring system includes coaxial cable.

12. The minibar of claim 10, wherein said wiring system is a cable TV wiring system.

13. The minibar of claim 10, wherein said wiring system is a telephone wiring system.

14. The minibar of claim 10, wherein said control system is configured to monitor a replacement of one of the inventory items.

15. The minibar of claim 10, wherein said power modem and said control system are configured, such that, a command can be received over said wiring system by said control system, such that, said control system performs a function.

16. The minibar of claim 10, further comprising a door and a locking device, said locking device being configured to lock said door, said power modem and said control system being configured, such that, a command can be received over said wiring system by said control system in order to lock said door.

17. The minibar of claim 10, further comprising an output unit, said power modem and said control system being configured, such that, a command can be received over said wiring system by said control system in order to actuate said output unit.

18. The minibar of claim 17, wherein said output unit is a display device.
